(19) United States
(12) Patent Application Publication
(10) Pub. No.: US 2007/0058763 A1
(43) Pub. Date: Mar. 15, 2007

(54) Device with adaptive equalizer

(75) Inventors: Rob Otte, Eindhoven (NL); Johannes Wilhelmus Maria Bergmans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/571,628

(22) PCT Filed: Sep. 13, 2004
(86) PCT No.: PCT/IB04/03005

§ 371 Date: Mar. 14, 2006

(30) Foreign Application Priority Data
Sep. 16, 2003 (EP) 03300118.1

(51) Int. Cl. H04L 7/00; H04L 27/06

(52) U.S. Cl. 375/355; 375/343; 375/344

(57) ABSTRACT

A device (200) with an adaptive equalizer (210) includes an adaption scheme performed in the synchronous domain. The equalizer coefficient update scheme is based on a correlation of an error sequence (delta k) derived from the equalized sequence transposed to the synchronous domain (Ek) and a synchronous and delayed version (Jk) of a vector of the equalizer tap values (Vn). The result of the correlation is further passed through an arrangement of integrators (226) and a temporal interpolator (228). The vector of equalizer tap values is converted into the synchronous domain by means of a bank of sampling rate converters (230) of which the overall implementation (300) can be simplified.

The invention relates to the field of digital transmission and recording. One or more embodiments of the invention relate to a novel topology for asynchronous LMS-based adaptive equalization.

U.S. Pat. No. 5,999,355, hereby incorporated by reference, discloses an asynchronous receiver comprising a tapped delay line equalizer with a tap spacing of Ts seconds, coupled to a sampling-rate converter (SRC). Control of the equalizer coefficients is based on the LMS (Least Mean Square) algorithm and the equalizer tap coefficients may be updated by correlation with a suitable error sequence. Conventional LMS techniques apply to synchronous receivers where error and tap-signal sequences have the same sampling rate and are phase synchronous. The asynchronous receiver described in this document thus includes at least two provisions to ensure that the tap-signal and error sequences have the same sampling rate and are phase synchronous. The latter condition implies that any latency in the error sequence should be matched by delaying the tap-signal sequence accordingly. Theses two provisions may be implemented using an inverse sampling rate conversion (ISRC) for converting the synchronous error sequence originally at the data rate 1/T into an equivalent error sequence with a sampling rate of 1/Ts, and using delay means to produce delayed versions of the equalizer tap-signal sequences to match the “round-trip” delay arising in the formation of the equivalent error sequence from the equalizer output. This “round-trip” delay is time varying because both SRC and inverse SRC introduce respective time-varying delays. The matching delay represents the expected or average value of the “round-trip” delay. Discrepancies between the “round-trip” and matching delays tend to cause the adaptation scheme to converge to an suboptimum solution. Furthermore, since the matching delay needs not be an integer number of symbol intervals Ts, implementation of the matching delay may require some form of interpolation. This, in addition to the use of the ISRC, adds to the complexity of the system so that the overall complexity of the adaptation-related circuitry exceeds that of synchronous LMS-based adaptation.

Another solution has been contemplated to overcome the problems mentioned above. Such solution is disclosed in European patent application 0102988.8 filed Nov. 21, 2002 of the same assignee as the present invention, this document being incorporated by reference herein. In this document, the equalizer tap coefficients are adapted under control of a timing-recovery loop in the synchronous domain contrary to the solution proposed in U.S. Pat. No. 5,999,355 where the adaptation is carried out in the asynchronous domain. To this end, the equalizer input is converted to the synchronous domain by means of an auxiliary SRC, and a fractional shift register produces synchronous versions of the tap-signal sequences. These synchronous tap-signal sequences are correlated with the synchronous error sequence to produce tap update information, later converted into tap coefficients via a bank of integrators. To close the adaptation loop, the output of the integrators bank is converted back to the asynchronous clock domain by means of an ISRC. Since tap coefficients change only slowly with respect to both 1/T and 1/Ts, the inverse sampling-rate conversion can be done in a simple conceivable manner, namely via a bank of latches.

The fractional shift register is meant to mimick the equalizer tap sequences, resampled at the baud rate 1/T. For the adaptation to work properly, the fractional shift register output is phase synchronized with the corresponding components of the error sequence before correlation, i.e. they should not be significantly delayed with respect to the actual resampled tap-signal sequences. For a fixed fractional shift register, this condition can only be met across a limited range of oversampling ratios T/Ts. The inventors have realised through experiments that the permissible range may be have to be limited to ±5% to obtain acceptable delays. However actual and future recording systems and digital transmission systems may exhibit a much larger range and a solution to this problem may be to subdivide the entire range into sub-ranges and use a single fractional shift register for each sub-range. Although the solution of using a plurality of fractional shift registers solves the delay issue associated with the range of the operating oversampling ratios, it may ultimately lead to a rather complex implementation of the timing-recovery loop.

The inventors have therefore sought a design that overcomes the problems associated with both prior art systems described herein while offering a satisfactory compromise as regards its implementation. The invention therefore relates to a device that includes an adaptive equalizer having a vector of equalizer tap coefficients and of corresponding tap-signal values and, such device is configured to deliver an asynchronous equalized sequence from an input sequence supplied at an asynchronous data rate. The device also comprises a main sampling rate converter that converts the asynchronous equalized sequence to the synchronous domain at a baud rate asynchronous to the so-called asynchronous data rate. An error detector derives an error sequence from the synchronous equalized sequence, which error sequence is later used by a control loop to control an update of the vector of equalizer tap values. To this end, the control loop comprises an arrangement of secondary sampling rate converters that convert the vector of equalizer tap coefficients to the synchronous domain. Once the vector is converted to the synchronous domain, it is correlated with the error sequence and based on the correlation, an adaptation arrangement controls the generation of an updated vector of equalizer tap coefficients in the asynchronous domain.

The invention depicts an alternative solution to the ones mentioned earlier. The invention is based in part on the premises that the correlation with the error sequence may be done on the basis of the vector of the equalizer tap values instead of the equalizer input sequence as proposed in the European document. As a consequence, the sampling rate converter present in the structure detailed in the European document may be replaced by the arrangement of sampling rate converters of the invention. Such subsitution may appear as an increase in the complexity of the structure, however the sampling rate converters within the arrangement are similar and operate at the same sampling phase. This permits a simplification in the actual implementation to the extent that the various sampling rate converters can be partly merged especially with respect to their control part. Moreover each individual sampling rate converter may be implemented in simpler manner relatively to the sampling rate converter of the prior art where aliasing and noise suppression may affect the bit error rate. Indeed, these two impediments, aliasing and noise, are essentially immaterial to the control path because aliasing and noise suppression do not affect the steady-state equalizer tap coefficients, thereby permitting the use of simple sampling rate converters as it is the case in the invention. In addition, the use of individual sampling rate converters in association with respective equalizer tap-signal values may turn out even more simple in systems where the equalizer has got only a few coefficients.

The invention and additional features, which may be optionally used to implement the invention, will be apparent and elucidated with reference to the drawings described hereinafter, wherein:

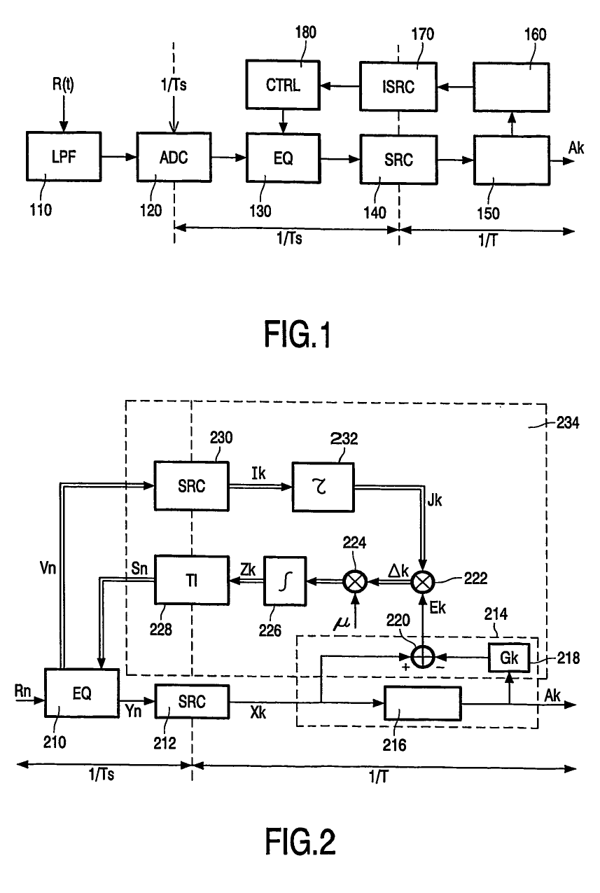

FIG. 1 is a conventional block diagram of a device built in with an asynchronous adaptive equalizer;

FIG. 2 is an alternative structure of a device of the invention; and,

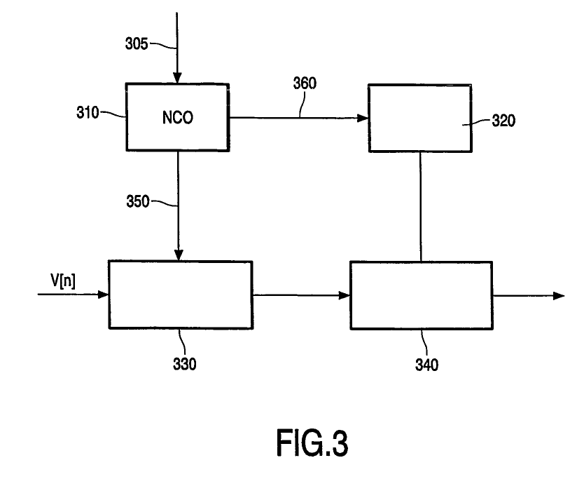

FIG. 3 is an examplary embodiment of a sampling rate converter.

Elements within the drawing having similar or corresponding features are identified by like reference numerals.

FIG. 1 is a conventional asynchronous base-band system 100 for digital transmission and recording systems. System 100 comprises for example a base-band receiver. System 100 generates a data sequence Aₖ at a baud rate 1/T from a received signal R(t). Received signal R(t) is applied to an analog low pass filter LPF 110 whose main function is to suppress out-of-band noise. The LPF 110 output is digitized by an analog-to-digital converter (ADC) 120 which operates at a crystal-controlled free-running sampling rate 1/Ts, asynchronous to the data rate 1/T, and the asychronous data rate 1/Ts is high enough to prevent aliasing. Output of ADC 120 is applied to an equalizer 130 at the sampling rate 1/Ts. A first sampling rate converter (SRC) 140 in the main transmission path produces an equivalent synchronous output equalized sequence which serves as an input to a bit detector 150 delivering the data sequence Ak. SRC 140 is comprised in a timing-recovery loop not depicted explicitely in FIG. 1.

To cope with variations of parameters of system 100, equalizer 130 often needs to be adaptive to new conditions. Error information is thus extracted from bit error detector 150 by an error formation circuit 160 and this error information is used to control the update the vector of equalizer tap coefficients of equalizer 130 via a control module 180. Generation of the error information occurs in the synchronous clock domain, while control of the adaptation occurs in the asynchronous domain. The error information is converted into the asynchronous domain by inverse SRC 170 coupled to the input of control module 180. Control module 180 derives a control signal based on the received asynchronous error information and causes an update of equalizer's 130 settings. Equalizer 130 may be a tapped delay line or finite impulse response filter with a tap spacing of Ts seconds. Update of its settings may include an update of its tap coefficients.

Existing asynchronous adaptation techniques are in some instances based on Least Mean Square (LMS) algorithms. With LMS, update information for equalizer 130 tap coefficients is derived by cross-correlating the tap-signal sequences with a suitable error sequence. For this to work, the tap-signal and error sequences need to be synchronous both in their sampling rates and in their phases. The first condition may be met with ISRC 170. The second one requires that the total latency of SRC 140, bit detector 150, error formation circuit 160 and ISRC 170 is matched by delaying the tap-signal values sequence accordingly, prior to cross-correlation. Both ISRC and delay matching add to the complexity of the solution. Delay matching, morover, may not be accurate because of the time varying nature of SRC 140 and ISRC 170. As a result, adaptation performance may degrade.

FIG. 2 is part of a block-diagram of an examplary embodiment of a device 200. Device 200 may, for example, comprise a base-band receiver of which a portion is shown in FIG. 2, namely the portion that performs the digital equalization. Device 200 comprises an adaptation structure that overcomes some of the disadvantages mentioned above. Device 200 comprises the following functional modules. First an adaptive equalizer 210 receives an asynchronous input sequence Rn that is previously digitized by an ADC at the asynchronous sampling rate 1/Ts. In operation, equalizer 210 is loaded with a vector Vn of equalizer tap-signal values with a tap spacing of Ts. Equalizer 210 is coupled to a first sampling rate converter SRC 212 and error generator 214 comprising a bit detector 216 providing an output channel data sequence Ak from the received input sequence Rn. Device 200 further comprises a adaptation loop 234 for adaptive equalization.

Loop 234 comprises a second SRC 230, an optional delay block 232, a first multiplier 222, a second optional multiplier 224, an integrator arrangement 226 and a temporal interpolator 228. Loop 234 produces tap update information by correlating the vector Vn of equalizer tap-signal values with an error signal sequence generated in module 214. Error and equalizer tap-signal values have the same sampling rate and are phase synchronous and consequently any latency in the error signal Ek should be matched by delaying the vector Vn of tap-signal values accordingly.

Sequence Rn denotes the sequence obtained by periodic sampling of e.g. an analog replay signal from a recording channel. Sampling is performed at a free-running clock rate 1/Ts which is generally not equal to the data rate 1/T. Sequence Rn is passed through equalizer 210 having Ts-spaced taps for producing an equalized sequence Yn at its output. Equalizer 210 may be an FIR (Finite Impulse Response) transversal filter or any equalizer that comprises a linear combiner. Equalizer 210 shapes the response of the recording or transmission channel to a prescribed target response and conditions the noise spectrum. Equalizer 210 removes channel interferences and aliasing effects. SRC 212 transforms the Ts-spaced equalized sequence Yn into an equivalent T-spaced sequence Xk supplied at the input of error generator 214. The T-spaced sequence Xk is synchronized to the data rate 1/T of the channel data sequence Ak. Assuming that the bit detector 216 comprised in error generator 214 produces correct decisions, the data sequence Ak and its estimate are identical. The output of error generator 214, or more precisely of built-in bit detector 216, is therefore denoted Ak It is agreed that occasional bit errors do not significantly affect the performance of the system.

Alternatively, at the beginning of transmission, a predetermined data sequence (often referred to as a preamble or training sequence) may precede the actual data sequence Rn in order for initial adaptation to be based on a replica of this predetermined data sequence, which can be stored or synthesized locally at device 200 without any bit error. It is common practice to perform the initial stage of adaptation in a so-called training mode, and to switch to the decision-directed mode of operation as presented in FIG. 2 once adaptation loops have converged. While not described here, it is understood that the invention also encompasses the training mode referred to above.

Control loop 234 is configured to adaptively update the control vector sequence Sn that determined the equalizer tap coefficients using LMS techniques. All digital operations performed in control loop 234, some of which are described hereinafter, may be realized by a microprocessor executing corresponding computer instructions. On FIG. 2, thick arrows between blocks indicate vector signals while scalar signals are indicated by thin arrows.

In this examplary embodiment control loop 234 comprises the following elements:
arrangement 230 of sampling rate converters for respectively converting the elements of vector Vn of equalizer tap-signal values into an intermediate vector sequence Ik at the data rate 1/T,
obtional delay tap 232 for delaying the intermediate vector sequence Ik with respect to the error sequence Ek to obtain an intermediate delayed vector sequence Jk,
multiplier 222 for multiplying the error sequence with the intermediate vector sequence Jk;
optional multiplier 224
corrector 226 that produces the synchronous control information vector Zk at the data rate 1/T from the correlation between the error sequence Ek and the intermediate vector sequence Jk,
and temporal interpolator 228 for deriving the control vector sequence Sn in the asynchronous time domain that is ultimately used to control the update of the equalizer tap coefficients.

The N-vector sequence Vn of equalizer tap-signal values is converted to the synchronous data rate domain by arrangement 230 that is comprised of individual sampling rate converters associated with each component of vector sequence Vn. Arrangement 230 therefore includes as many individual SRCs as equalizer 210 has got taps, i.e. N. Physical implementation of arrangement 230 may be simplified by combining common functions of the identical sampling rate converters such as the control function. A simple implementation may therefore be achieved.

To illustrate these simplifications, FIG. 3 depicts a typical sampling rate converter 300 taken from Appendix 9A of “Digital Baseband Transmission and Recording” by J. W. M. Bergamsn (Kluwer Academic Publishers, 1996). The pacing element of converter 300 is a numerically controlled oscillator (NCO) 310 whose frequency is controlled by an NCO control signal 305. Output of NCO 310 has an integer part 350 and a fractional part 360. Integer part 350 serves to demarcate a window of consecutive samples that is selected from the incoming signal V(n) in sample selector block 330. The selected window of samples is subsequently applied to an interpolator 340, whose coefficients are selected depending on the fractional NCO part 360. The integer and fractional parts 350, 360 are identical for all SRCs in FIG. 2, and hence only a single NCO 330 is needed. Furthermore interpolation coefficients are identical, the respective interpolators 340 perform exactly the same transformation, and it suffices in principle to employ only a single physical interpolator 340 and re-use it N times for the N respective signal components. These options all help to simplify the physical implementation of arrangement 230.

SRC 212 may need to obey high accuracy requirements in order to achieve a high delay accuracy and adequate suppression of aliasing components and out-of-band nose. Interpolator comprised within SRC 212 tends to be complex, and tends to increase the complexity of the sampling rate converter 212 as a whole. Sampling rate converters of arrangement 230, by comparison, do not need to achieve a large suppression of aliasing components and out-of-band noise, since these two artifacts do not affect the steady-state equalizer settings and as such do not affect the performance of bit detector 216. Interpolators comprised within arrangement 230 can therefore be much simpler than the one in SRC 212, and the complete arrangement 230 can therefore be much simpler than the one in SRC 212, and the complete arrangement 230 can be much less than N times as complicated as SRC 212, especially if the simplifications outlined above are also accounted for. For small N, overall complexity of arrangement 230 may, in fact, be comparable to or smaller than that of SRC 212.

Intermediate sequence Ik produced by arrangement 230 is in the synchronous domain, and is optionally delayed by a predefined delay in block 232 to obtain a delayed intermediate sequence Jk. Delay block 232 introduces a predefined delay to compensate for any operational delay of the signal main path via SRC 212 and error formation circuit 214. This predefined delay depends only on the implementation of SRS 212 and error formation circuit 214, and is hence known precisely, irrespective of the actual operating parameters of device 200.

The synchronous control vector sequence Zk produced by corrector 226 is derived from a cross product ek.Jk where Jk is the intermediate delayed vector sequence in the synchronous domain derived from the vector sequence Vn. Vector Zk may have Ni components and may be produced by a bank of Ni integrators comprised in corrector 226.

The variable at the output of corrector 226, denoted Zₖⁱ, obey the following mathematical relationship (1):
Zₖ₊₁ⁱ=Zₖⁱ+μΔₖⁱ, i=0, . . . , N−1 (1)
where:
Zₖⁱ is the output of the j-th integrator at instant k
μ is a small scaling factor (or step size) which determines closed-loop constants,
Δₖⁱ is a tap error estimate at iteration k, and
N is the number of equalizer taps.

According to the LMS scheme, the estimate Δₖⁱ is given by the following mathematical relationship (2):
Δₖⁱ=ek.Jₖ₋ⱼ, j=0, . . . , N−1 (2)
where:
ek is the error between output of SRC 212 and a desired detector input dk=(a*g)ₖ, with gₖ being the target response for the equalizer adaptation stored in block 218,
_{Jk-j} is a component of the delayed version of the vector Vn of equalizer tap values converted into the data rate 1/T.

It must be noted that equation (2) and FIG. 2 only describe one of the various possible approaches to derive tap error estimates Δₖⁱ from the error sequence Ek and the vector Vn. For example, either of the two sequences Ek or Vn can be quantized so as to simplify the implementation of control loop 234 and the multiplication operation in equation (2) can be replaced by a selective update mechanism.

FIG. 2 shows that the synchronous control vector sequence Zk at the output of corrector 226 is updated every T second (synchronous domain), while the equalizer tap coefficients may need to be updated every Ts seconds, since the equalizer operates in the asynchronous domain. The necessary time-base conversion is performed through temporal interpolation module 228 for deriving an asynchronous control vector sequence Sn at the sampling rate 1/Ts from the synchronous control vector sequence Zk at the output of corrector 228 and its bank of integrators. Since tap values change only slowly with respect to both sampling rates, the temporal interpolation can be done in a simple conceivable manner, e.g. via a bank of latches performing zeroth-order interpolation. When Ts deviates too much from T, an additional issue is raised, which may require spatial interpolation. To this respect, reference is made to European patent application 0102988.8 previously incorporated by reference herein. This document describes a possible spatial interpolation implementation which may be transposed to the embodiment of FIG. 2.

The drawings and their description presented herein illustrate rather than limit the scope of the invention. For example, error sequence Ek in FIG. 2 may be quantized, to as little as one bit, so as to further simplify the implementation of device 200. Also in cases where the error sequence Ek is colored, a suitable filter may be inserted in either or both of the two input branches of correlator 222 so as to improve adaptation performances.

It will be evident to one skilled in the art that numerous other alternatives fall within the scopes of the appended claims. In this respect, the following closing remarks are made. There are numerous ways of implementing functions by means of items of hardware or software, or both. For example, the drawings presented here are diagrammatic, each only representing one embodiment. Thus, although a drawing shows different functions as different blocks, this by no means excludes that a single item of hardware or software carries out several functions. Nor does it exclude that a function is carried out by an assembly of items of hardware or software, or both.

1. A device comprising:
an adaptive equalizer having equalizer tap coefficients and configured to deliver an asynchronous equalized sequence from an input sequence supplied at an asynchronous data rate;
a main sampling rate converter for converting the asynchronous equalized sequence to a synchronous equalized sequence at a synchronous baud rate asynchronous to the asynchronous data rate;
an error detector for determining a synchronous error sequence from the synchronous equalized sequence;
a control loop configured to control an update of the equalizer tap coefficients, the control loop comprising:
an arrangement of secondary sampling rate converters for converting into the synchronous domain a vector of equalizer tap values respectively associated with the equalizer tap coefficients;
a correlator for correlating the error sequence with the vector of equalizer tap values converted to the synchronous domain;
a correction arrangement for enabling a generation of a control signal in the asynchronous time domain causing an update of the equalizer tap coefficients, the control signal being generated based on the correlating.

2. The device of claim 1, wherein the correction arrangement comprises:
at least one integrator to produce an update information from the correlation;
a temporal interpolator to generate the control signal by converting the update information to the synchronous domain and the control signal being fed back to the equalizer causing the update of the equalizer tap coefficients.

3. The device of claim 2, wherein the temporal interpolator comprises seroth-order interpolation means.

4. The device of claim 2, wherein the temporal interpolator comprises at least a latch associated with a component of the update information.

5. The device of claim 1, further comprising:
a delay block for delaying the synchronous equalized sequence by a delay determined based on a functional delay introduced by the main sampling rate converter.

6. A system comprising:
a transmitter for transmitting a communication signal via a communication channel;
a receiver for extracting the communication signal from the communication channel, the receiver comprising:
an adaptive equalizer having equalizer tap coefficients and configured to deliver an asynchronous equalized sequence from an input sequence supplied at an asynchronous data rate and derived from the communication signal;
a main sampling rate converter for converting the asynchronous equalized sequence to a synchronous equalized sequence at a synchronous baud rate asynchronous to the asynchronous data rate;
an error detector for determining a synchronous error sequence from the synchronous equalized sequence;
a control loop configured to control an update of the equalizer tap coefficients, the control loop comprising:
an arrangement of secondary sampling rate converters for converting into the synchronous domain a vector of equalizer tap values respectively associated with the equalizer tap coefficients;
a correlator for correlating the error sequence with the vector of equalizer tap values converted to the synchronous domain;
a correction arrangement for enabling a generation of a control signal in the asynchronous time domain causing an update of the equalizer tap coefficients, the control signal being generated based on the correlation.

7. An equalizer adaptation method, the method comprising:
equalizing an input sequence supplied at an asynchronous data rate using equalizer tap coefficients, resulting in an asynchronous equalized sequence;
converting the asynchronous equalized sequence to a synchronous equalized sequence at a synchronous baud rate asynchronous to the asynchronous data rate;
determining an error sequence from the synchronous equalized sequence;
controlling an update of the equalizer tap coefficients, the controlling comprising:
converting into the synchronous domain a vector of equalizer tap values respectively associated with the equalizer tap coefficients;
correlating the error sequence with the vector of equalizer tap values converted to the synchronous domain;
enabling a generation of a control signal in the asynchronous time domain causing an update of the equalizer tap coefficients, the control signal being generated based on the correlation.

8. A computer program product for a device computing a set of instructions which when loaded into the device, causes the device to carry out the method as claimed in claim 7.

9. A signal for carrying out a computer program, the computer program being arranged to carry out the method as claimed in claim 7.
